(19) United States
(12) Patent Application Publication
(10) Pub. No.: US 2003/0003018 A1
(43) Pub. Date: Jan. 2, 2003

(54) Systems and apparatus for the analysis of molecular interactions

(75) Inventors: Mark L. Stolowitz, Pleasanton, CA (US); Robert J. Kaiser, Bothell, WA (US); Leslie E. Linkkila, Kingston, WA (US); Charles E. Dubuque, Menlo Park, CA (US); Michael E. Baum, Seattle, WA (US); Erik M. Engstrom, Covington, WA (US); Stephen M. Bailey, Seattle, WA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Prolinx Incorporated, Bothell, WA (US)

(21) Appl. No.: 10/115,870

(22) Filed: Apr. 2, 2002

Related U.S. Application Data
(60) Provisional application No. 60/281,094, filed on Apr. 2, 2001.
(60) Provisional application No. 60/360,798, filed on Mar. 1, 2002.

(51) Int. Cl. G01N 21/00

(52) U.S. Cl. 422/82.05; 422/82.11

(57) ABSTRACT

Instruments and systems for the analysis of molecular interactions with enhanced throughput and ease-of-use. In certain aspects, the systems and instruments include miniaturized SPR-based sensors and novel sensor surface chemistry to provide high-throughput automated instruments and systems for molecular interaction analysis.

### CROSS-REFERENCES TO RELATED APPLICATIONS

This application claims the benefit of U.S. Provisional Application Serial Nos. 60/281,094, entitled “Biosensors”, filed Apr. 2, 2001, and 60/360,798, entitled “An Apparatus for the Analysis of Molecular Interactions”, filed Mar. 1, 2002, each of which is hereby incorporated by reference in its entirety for all purposes.

### BACKGROUND OF THE INVENTION

The present invention relates generally to biosensor systems, methods and apparatus, and more particularly to sensing systems, methods and apparatus using surface plasmon resonance (SPR) detection for molecular interaction analysis.

Molecular Interaction Analysis

Biological processes are governed by the temporal and spatial interactions between molecules. Basic parameters which characterize these interactions include reaction stoichiometry, concentrations of interacting species, equilibrium (affinity) constants, kinetic (rate) constants, and specificity of interaction as functions of temperature and solution composition (pH, ionic strength). The in vitro determination of these parameters for a system of interest can provide important insight into the molecular basis of fundamental metabolic processes, supply essential information for the diagnosis of disease and help identify promising therapeutic candidates. Hence, molecular interaction analysis plays an important role in basic biological science as well as medicine. Table I summarizes the diversity of recently published applications of molecular interaction analysis.

TABLE I
Diversity of recently published applications of molecular interaction
analysis [information from (see, Rich, R. L. and Myszka, D. G. Curr.
Opin. Biotechnol. 11, 54-61 (2000))].

Drug discovery (lead identification, target validation)
Ligand fishing
Comparative binding specificity
Mutation studies, structure-function relationships
Cell signaling
Replication, transcription, regulation
Multi-molecular complexes
Immune regulation
Immunoassays
Vaccine development
Chromatographic process development

Surface Plasmon Resonance

Surface plasmon resonance (SPR) is a label-free optical detection technology that has proven extremely useful in the analysis of molecular interactions for over a decade. The technology provides a real-time method for measuring the interaction(s) between two or more molecules, one of which is tethered to a solid surface (see, Schuck, P., Annu. Rev. Biophys. Biomol. Struct. 26, 541-566 (1997)). Molecules used in such studies to date include: proteins, peptides, nucleic acids, carbohydrates, lipids and low molecular weight substances (e.g., hormones, pharmaceuticals) (see, Myszka, D. G., J. Mol. Recognit. 12, 390-48 (1999)). Indeed, interactions between immobilized cells and ligands to cell surface receptors have been studied (see, Myszka, D. G., J. Mol. Recognit. 12, 390-48 (1999)).

A surface plasmon is the oscillation of free electrons which is present at the surface of a conductor such as a metal. Surface plasmon resonance occurs under conditions of total internal reflection in a metal film present at the boundary between two substances of different refractive indices, such as water and glass. An incident monochromatic light beam in the first medium creates an evanescent wave at the point of reflection that crosses a short distance beyond the boundary. The evanescent wave couples with the surface plasmons in the metal at a particular angle of incidence that depends on the refractive index of the second medium. Energy is absorbed, with the result that the intensity of the reflected light is attenuated relative to the incident light. Thus, measurement of reflected light intensity as a function of angle of incidence can be used to monitor changes in the refractive index of the medium near the metal surface (see, Liedberg et al., Lab. Sensors and Actuators 4, 299-304 (1983)).

The implementation of SPR as a detection technology for molecular interaction analysis is illustrated by the following simplified example which is depicted in FIG. 1 (see, Nice, E. C. and Catimel, B., BioEssays 21, 339-352 (1999); Salamon et al., U.S. Pat. No. 5,991,488 (1999)). A thin film of a conducting metal, typically gold, is deposited on the surface of a glass prism. A molecular recognition element, such as an antibody or other protein receptor, is immobilized in a molecularly thin layer on the surface of the metal film using any of a variety of methods. Monochromatic light is then directed onto the gold film by the prism. The gold film is brought in contact with a stream of flowing solution containing the (putative) binding partner(s) for the immobilized recognition element. As the binding partner interacts with the surface immobilized recognition element, the dielectric value (and thus refractive index) of the material on the metal surface changes. This change in refractive index causes a change in the angle of the incident light beam required for maximal coupling into the surface plasmons. The incident light beam is scanned through a variety of angles and the angle of minimum reflected intensity is measured. If this measurement is made and plotted as a function of time, the result is a curve that characterizes the binding or association process. If the solution with binding partner is now replaced with a solution that is devoid of the binding partner, bound analyte is released yielding a curve that characterizes this dissociation process. Kinetic and equilibrium constants characterizing the interaction can be mathematically extracted from this data based on given binding models.

With the recent availability of complete genome sequences, the way in which basic biological science is now being and will be performed in the future has been revolutionized. Newly coined terms such as “proteomics”, “cellomics” and “metabolomics” reflect a fundamental shift in biological research from the characterization of isolated molecules or cells to the analysis and understanding of biological systems as integrated and interactive networks. A key to the successful realization of the analysis of complete biological systems and processes is the development of powerful technologies that will enable the interrogation of complex assemblies of molecules with sufficient throughput to match the scope of the endeavor.

It is therefore desirable to provide novel instruments and systems for the analysis of molecular interactions with increased throughput and ease-of-use. Preferably such systems should use superior surface chemistry to provide improved sample immobilization and SPR detection techniques to take advantage of real-time data acquisition capabilities.

### BRIEF SUMMARY OF THE INVENTION

The present invention provides novel instruments and systems for the analysis of molecular interactions with increased throughput and ease-of-use. In particular, the present invention combines novel miniaturized SPR-based sensors with reliable and easy-to-use surface chemistry to provide high-throughput automated instruments and systems for molecular interaction analysis.

According to an aspect of the present invention, a sensor system is provided that typically includes a sensor holding assembly configured to hold a plurality of SPR-based sensors such that the sensing surfaces of two or more inserted sensors are aligned in an array. The sensor system also typically includes a system for delivery and removal of liquids containing samples, a liquid handling system positioned proximal to the sensor holding assembly and having a head including two or more dispensing members, wherein the liquid handling system assembly is configured to automatically move the head proximal the sensor holding assembly such that the ends of the two or more dispensing members are proximal the sensing surfaces of the two or more inserted sensors.

According to another aspect of the present invention, an apparatus is provided for holding two or more SPR-based sensors, each sensor having a sensing surface. The apparatus typically includes a base, a platform coupled to the base, and a sensor holding block configured to removably attach to the platform, the block including two or more sensor receiving locations with each location configured to receive one of the sensors, wherein the receiving locations are arranged so as to present the sensing surfaces in an aligned array.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings. In the drawings, like reference numbers indicate identical or functionally similar elements.

### BRIEF DESCRIPTION OF THE DRAWINGS

FIG. 1. (A and B) One configuration for molecular interaction analysis using SPR detection as described in the text. The drawing in (A) represents the system in the absence of the binding partner for the recognition element; (B) represents the system in the presence of a saturating amount of the binding partner. (C) Raw SPR data. The red curves represent the dependence of the reflected light intensity as a function of angle of incidence θ. Position I is the angle of incidence for minimum reflected light intensity in the absence of binding partner. Position II is the angle of incidence for minimum reflected light intensity in the presence of a saturating amount of binding partner. (D) Plot of the angular position of the minimum of the curve with time. The association and dissociation phases are as described in the text. This curve is typically referred to as a “sensorgram”.

FIG. 2. The Versalinx™ Chemical Affinity Tools are based on the specific interaction between phenyl(di)boronic acid (P(D)BA) and salicylhydroxamic acid (SHA). These two molecules form a coordinate covalent complex under variety of conditions, the only byproduct of which is an equivalent of water. The complex can be reversed into its component parts under appropriate conditions.

FIG. 3 illustrates the components of the Spreeta™ 2000 SPR sensor. The inset photograph provides an indication of the actual size of the device relative to a U.S. dime.

FIG. 4a illustrates an isometric view of a molecular interaction analysis system including a modular sensor unit and a robotic liquid handling system according to an embodiment of the present invention.

FIGS. 4b-d illustrate top, front, and side views, respectively, of the system of FIG. 4a.

FIGS. 5a-f illustrate various isometric views of a modular sensor unit according to an embodiment of the present invention.

FIGS. 6a-e show various isometric views illustrating the process of removing a thermal block from, or inserting into, the housing of a modular sensor unit according to an embodiment of the invention.

FIGS. 7a and b illustrate detailed cross-sectional views of a modular sensor unit, including a loaded thermal block, taken at sections A-A and B-B as indicated in FIG. 5g, respectively.

FIG. 8 illustrates various components of a modular sensor unit according to an embodiment of the invention.

FIGS. 9a-d are isometric views of a thermal block according to an embodiment of the invention.

FIG. 10 illustrates various components of a thermal block according to an embodiment of the invention.

FIGS. 11 a-d illustrate a sensor module assembly (e.g., cartridge) according to an embodiment of the present invention.

FIGS. 12 and 13 illustrate sensor module assemblies according to embodiments of the invention.

FIGS. 14a and b illustrate a side view of analytical system and a close-up of the liquid handling system in position proximal the sample wells of the sensor unit, respectively, according to an embodiment of the invention.

FIG. 15 illustrates an analytical system including a liquid dispensing mechanism configured for manual delivery of samples to the sensor unit according to an embodiment of the invention.

FIG. 16 shows typical SPR data (left-hand plot) and baseline noise (right-hand plot) for a typical Spreeta™ 2000 sensor.

FIG. 17 illustrates a general overview of a computer-based analysis system including a host computer system communicably coupled to a molecular interaction analysis system according to an embodiment of the present invention.

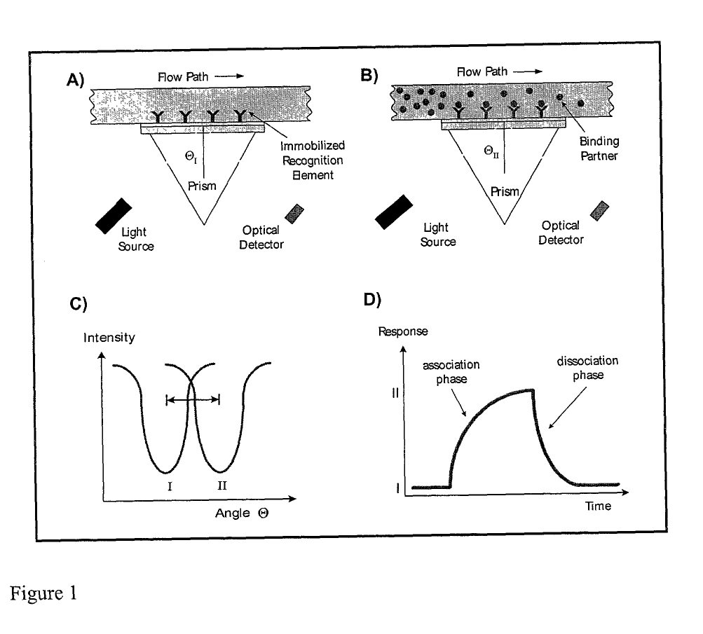

### DETAILED DESCRIPTION OF THE INVENTION

The present invention provides novel molecular interaction analysis systems, instruments and methods. In one embodiment, the systems of the present invention incorporate a known SPR sensor, the Spreeta™ 2000, as will be discussed herein, due primarily to its ease of integration with standard technology compatible with microtiter formats (e.g., spacings). Thus, although the following will discuss systems of the present invention with particular reference to Spreeta™ 2000 SPR sensor(s), it should be appreciated by one skilled in the art that the present invention is applicable to other SPR-based sensors and even non-SPR-based sensors. Additionally, in one embodiment, the systems of the present invention incorporate specific chemical affinity tools known as Versalinx™ Tools, to optimize immobilization of samples on sensor surfaces. It should be appreciated by one skilled in the art, however, that other chemical affinity tools, compounds, etc, that provide sample immobilization may be used.

I. The Spreeta™ 2000 Sensor

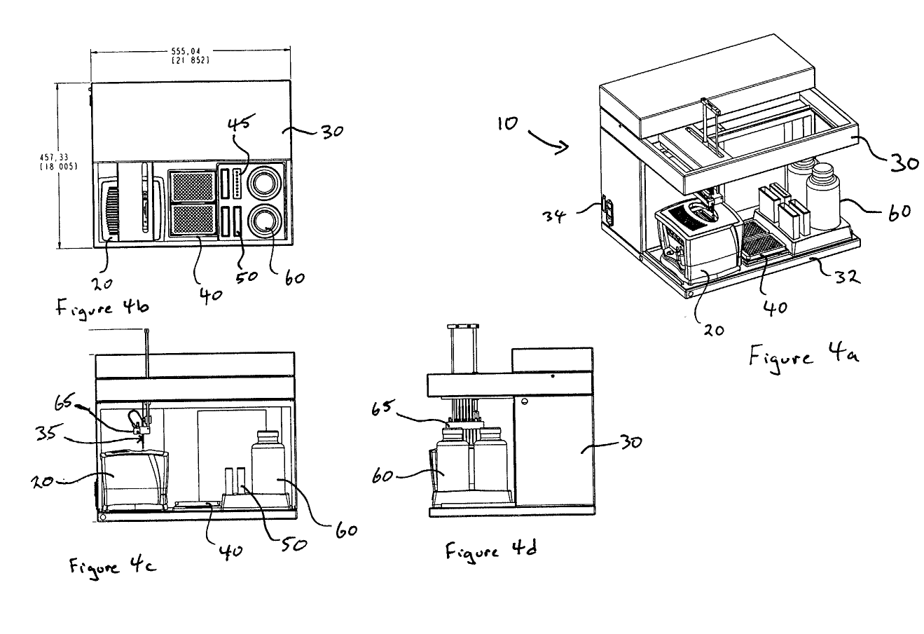

In 1996, Texas Instruments, Inc. demonstrated the first fully integrated miniature technology for refractive index sensing using surface plasmon resonance (see, Melendez et al., Sens. Actuators B 35, 1-5 (1996)). One recent implementation of this technology is a sensor device, trade-named Spreeta™ 2000, that includes optics and electronics necessary for the acquisition of SPR data in a miniaturized device. A drawing and a photograph of the sensor device are shown in FIG. 3. The sensor device includes: a printed circuit board upon which are installed a light source (830 nm light emitting diode), a photodetector (128 pixel linear photodiode array), and a memory chip along with some electronic circuitry; an optical plastic “sail” that acts as a waveguide to focus light on the gold sensing surface (surface plasmon layer); and a mirror atop the optical sail to re-direct the reflected light to the photodetector. The short light path of the device results in excellent detection sensitivity. The card-edge connector allows the device to interface with state-of-the-art digital signal processing (DSP) electronics, allowing the high-speed collection of SPR curves in real-time. A resident memory chip (16 kilobit) can be utilized for storage of sensor identification information, calibration data, use history and the like. Additionally, the Spreeta™ 2000 has a footprint that allows multiple sensors to be aligned side-by-side on 9 mm centers. U.S. Pat. No. 6,138,696 discusses aspects of an SPR-based sensor such as the Spreeta™ 2000, and is hereby incorporated by reference in its entirety.

II. The Versalinx™ Chemical Affinity Tools

SPR-based molecular interaction analysis requires that a molecular recognition element be immobilized on the surface of the metal film employed for SPR. Therefore, an immobilization chemistry appropriate to the molecules being studied is a necessity. In certain aspects, the surface chemistry of the present invention is:

efficient, easy to perform, reproducible and predictable;

flexible enough to be applicable to a wide variety of molecular species;

optimally presents the immobilized molecules to the incoming binding partners such that full and specific biological activity is retained; and

minimal non-specific binding of analytes to prevent loss of detection sensitivity and specificity.

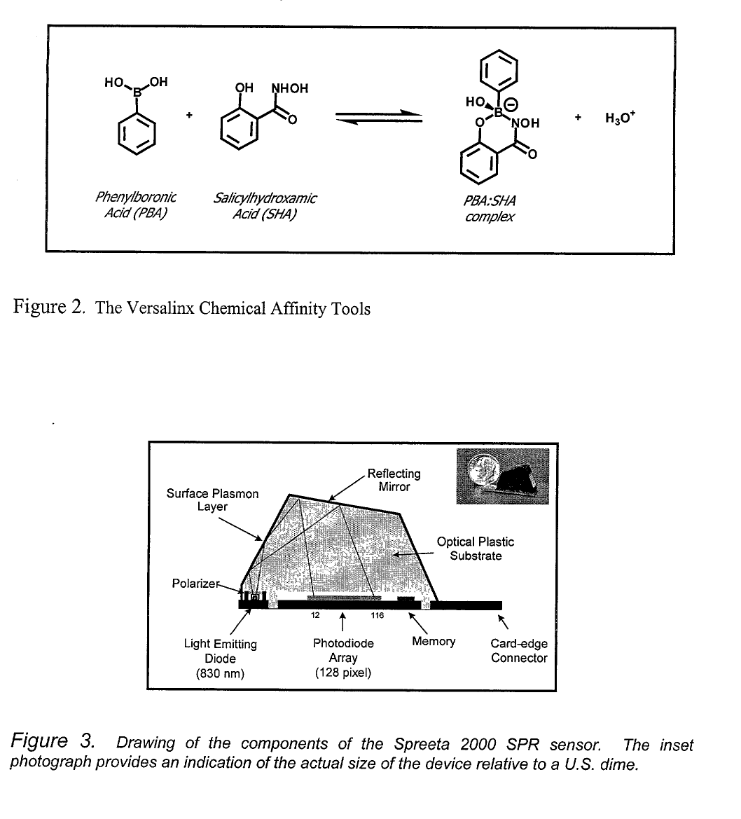

The Versalinx™ Chemical Affinity Tools are a novel system for the immobilization of biological macromolecules. They are based on the highly specific complex formation between two families of small molecules, the simplest representatives of which are phenyl(di)boronic acid (P(D)BA) and salicylhydroxamic acid (SHA) (see, Stolowitz et al., Bioconjugate Chem. 12, 229-239 (2001); Wiley et al., Bioconjugate Chem. 12, 240-250 (2001)). In one aspect, this interaction is depicted in FIG. 2. The only byproduct of complex formation is an equivalent of water. The complex can be dissociated into its component parts either at extremes of pH or by using competitive binding reagents.

Complex formation occurs readily in aqueous solution in the pH range 5 to 9. It forms in the presence of most buffer systems; monovalent and divalent inorganic salts to 1.5 M; chaotropes such as urea and guanidine hydrochloride; organic solvents such as dimethyl sulfoxide and simple aliphatic alcohols; and detergents such as sodium dodecyl sulfate. In addition, once the complex is formed, it is stable under an even greater range of solution conditions.

The Versalinx™ Chemical Affinity Tools include a series of reagents that enable the immobilization of biomolecules on solid surfaces by virtue of, for example, P(D)BA:SHA complex formation. In general, the strategy for biomolecule immobilization is as follows. A solid surface is chemically derivatized with SHA using one of several chemical alternatives. The biomolecule to be immobilized is optimally conjugated with an appropriate P(D)BA reagent. The P(D)BA-conjugated biomolecule is contacted with the SHA-modified surface, and rapid immobilization due to P(D)BA:SHA complex formation occurs. Excess P(D)BA-conjugated biomolecule (if any) is removed by washing, and the surface is ready to use.

The Versalinx™ Tools approach to biomolecule immobilization has several powerful attributes for SPR-based molecular interaction analysis. First, it provides a single, universal SHA-modified surface that can be used to immobilize any P(D)BA-conjugated biomolecule. Biomolecule conjugation with P(D)BA is very flexible, as P(D)BA derivatives are available for modifying amines (active ester), thiols (maleimide), oxidized carbohydrates (hydrazide), oligonucleotides (phosphoramidite), DNA (dUTP), RNA (UTP) and the like. Analyses can thus be performed using immobilized biomolecules, proteins, carbohydrates, nucleic acids, etc. on a single type of sensor surface using the same immobilization chemistry. Additionally, SHA-modified surfaces typically show very little interaction with non-P(D)BA labeled biomolecules, resulting in very low noise levels due to non-specific binding. Also, the sensor surface may be regenerated for subsequent analyses using the same immobilized recognition element by chemically removing the binding partner, or it may be stripped to the native SHA surface for reconstitution with the same or a different recognition molecule. In some cases, it may be possible to remove intact recognition element/binding partner complexes for further analysis (e.g., mass spectroscopy) using competitive reversal of the P(D)BA:SHA complex.

It has been empirically observed that immobilization of biomolecules using Versalinx™ Tools typically results in a higher retention of biological activity of the surface-bound species relative to alternative methods of surface immobilization.

A. Sensor Surface Chemistry

Versalinx™ reagents have been developed that allow the incorporation of SHA on the surface of a free electron metal, such as a gold film, through the formation of a binary self-assembled monolayer (SAM), a well-characterized process (see, Prime, K. L. and Whitesides, G. M, Science 252, 1164-1167 (1991); Lahiri et al., Anal. Chem. 71, 777-790 (1999)). This SHA-SAM is designed to provide optimal immobilization of P(D)BA-conjugated biomolecules as well as to exhibit extremely low non-specific binding. The molecularly thin, uniform SAM lessens the complicating effects of inefficient or obstructed mass transport during the association and dissociation processes. It also minimizes loss of SPR sensitivity due to its close proximity to the gold surface (SPR sensitivity decreases exponentially with distance from the metal film). Immobilization of P(D)BA-conjugated recognition elements takes place rapidly (e.g., 15 to 60 minutes). The density of immobilized biomolecule can be easily tuned by adjusting the quantity of input material. Degraded or spent surfaces can be stripped of immobilized species and reconstituted with fresh P(D)BA-conjugate. Co-pending U.S. patent Application Ser. Nos. [ ] (Attorney docket No. 17635-001610), and [ ], (Attorney docket No.17635-001710), filed on even date herewith, each disclose novel surface chemistries useful for providing improved immobilization of biomolecules in the systems and instruments of the present invention. The foregoing co-pending Patent Applications are each hereby incorporated by reference in its entirety.

III. Molecular Interaction Analysis System

The Versalinx™ Chemical Affinity Tools coupled with an SPR-based sensor, such as the Spreeta™ 2000 sensor, enable the development of unique instruments and systems for increased throughput molecular interaction analysis according to embodiments of the present invention as presented herein.

A. System Design

In preferred aspects, the size and design of the Spreeta™ 2000 sensor allows for multiple sensors (sensor array) to be aligned side-by-side on 9 mm centers. Such an alignment corresponds with the well-to-well spacing in industry standard multi-well plates, e.g., 8×12 multi-well sample plates, commonly used in biological research. Advantageously, a system according to the present invention combines a robotic liquid handling system for manipulating samples stored in multi-well plates with a small, modular sensor unit containing multiple sensors, such as Spreeta™ 2000 sensors or other sensors, to achieve high-throughput molecular interaction analysis.

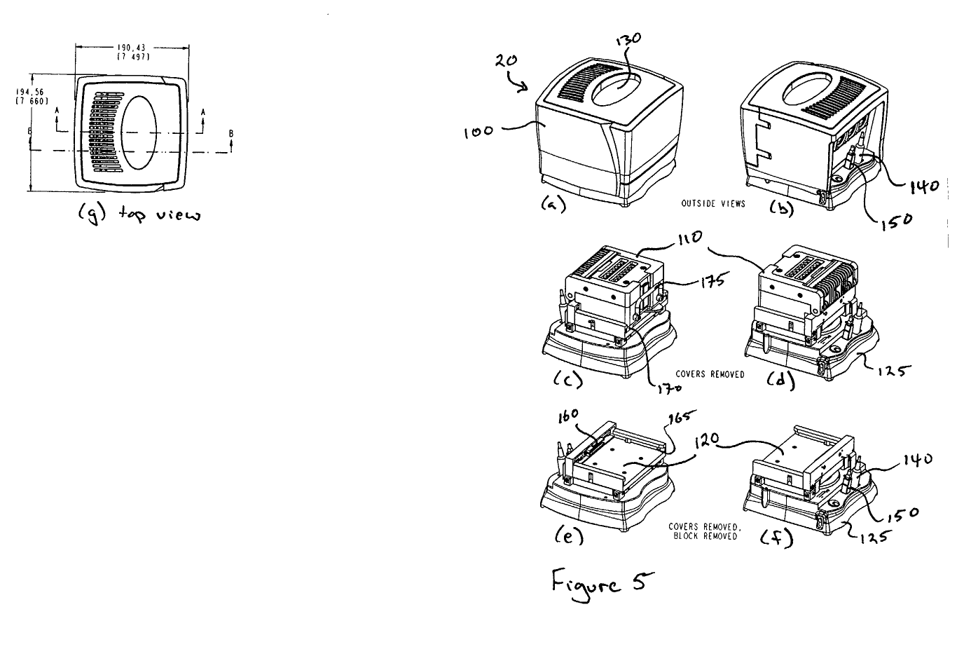

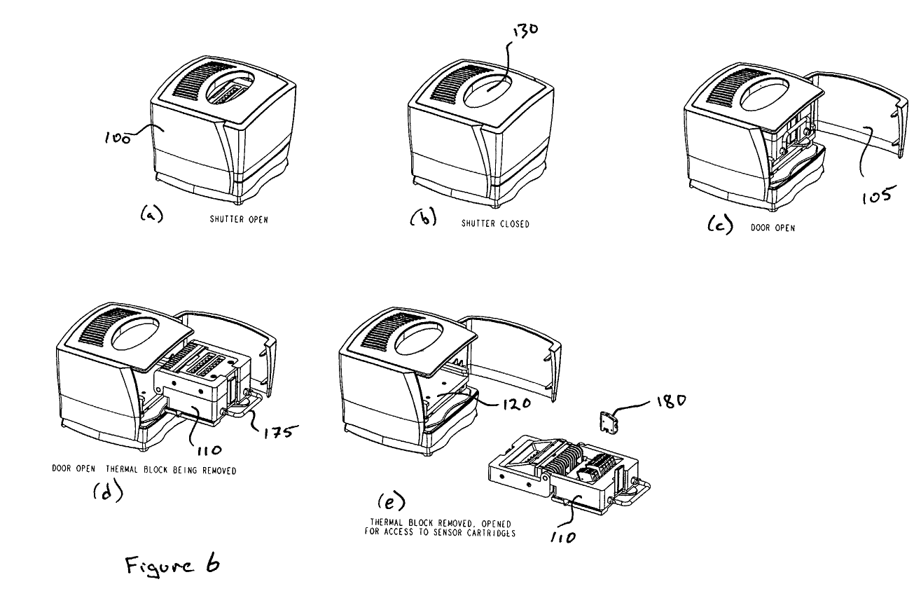

FIG. 4a illustrates an isometric view of a molecular interaction analysis system 10 including a modular sensor unit 20 and a robotic liquid handling system 30 according to an embodiment of the present invention. FIGS. 4b-d illustrate top, front, and side views, respectively, of molecular interaction analysis system 10. Sensor unit 20 is configured, as will be described below, to hold an array of sensors, e.g., up to eight sensor modules, such as modules including Spreeta™ 2000 sensors, in an array to allow the liquid dispensing mechanisms of the liquid handling system 30 to deliver desired amounts and types of samples to the active sensing portions of the sensors.

B. Liquid Handling System

In a preferred aspect, liquid handling is performed automatically using a three axis robot 30 such as a modified Tecan Systems MSP9000, which is a rugged and reliable OEM instrument for liquid handling in multi-well plate format. The footprint of the Tecan Systems MSP9000 robot (minus computer) is approximately 22 inches wide by 19 inches deep, and it is about 20 inches high, so that it occupies a relatively small amount of bench space. It should be understood that other OEM or custom made robotic liquid handling assemblies may be used.

In one embodiment as shown in FIG. 4, the deck 32 of robot 30 is configured to hold modular sensor unit 20, two multi-well sample plates 40, a wash station 45 for washing the liquid handling probes 35, up to three solution stations 50, and wash buffer and waste bottles 60. Liquids (e.g., samples, solutions, reagents, analytes, etc.) are transferred by three-dimensional translation of the liquid handling head 65. Head 65, in one embodiment, includes eight dual-needle probes 35. One needle of each probe is connected to an 8-channel syringe pump for precision transfer of sample solutions, regeneration buffer, and the like among the multi-well plates 40, sensor wells, pre-conditioning wells and solution stations. Additionally, liquid from the wash buffer bottle 60 is delivered through these needles. Liquid transfer and wash buffer delivery is controlled by a solenoid valve on each syringe. The other needle is used to aspirate liquids to waste using a diaphragm pump, primarily during probe washing cycles. In one embodiment, all transfers by the liquid head 65 are performed in a row of eight at a time using a single set of transfer parameters. In another embodiment, transfer is performed in individually selected probes (e.g., from only one up to seven, or all eight).

Communication between a control computer (see, e.g., FIG. 17) and the modular sensor unit 20 utilizes a USB 1.x interface, although other interface types may be used, e.g., PCI, USB 2.x, FireWire (also known as IEEE 1394), serial port (RS232), Ethernet, etc. Communication with the liquid handling system 30 preferably passes through the sensor unit 20 to manage command sequencing and timing more efficiently, although a communication port 34 (e.g., PCI, USB 2.x, FireWire (also known as IEEE 1394), serial port (RS232), Ethernet, etc.) is provided for direct communication with liquid handling system 30. Data is advantageously acquired and stored from all sensor modules in the sensor unit 20 simultaneously.

C. Modular Sensor Unit

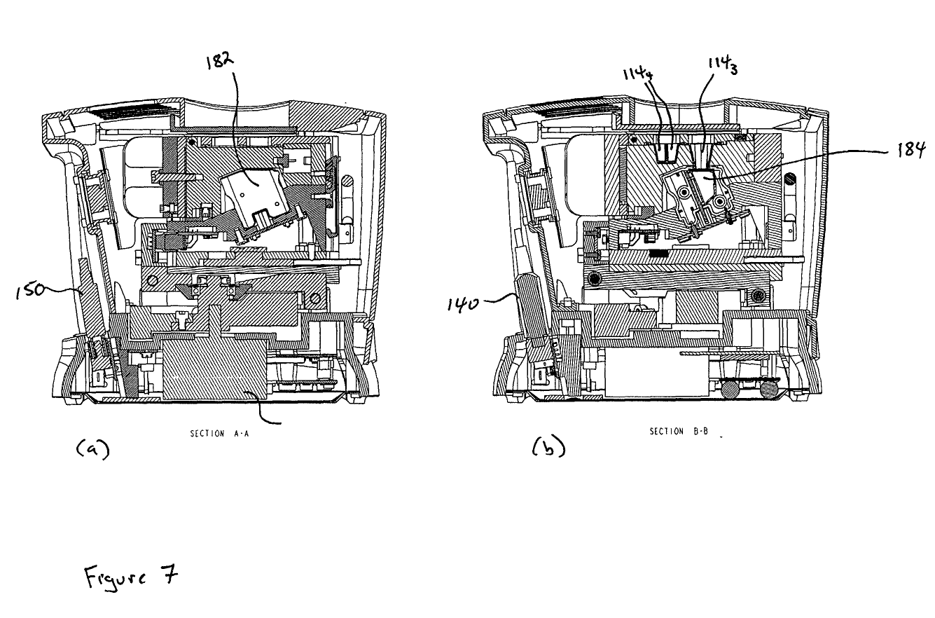

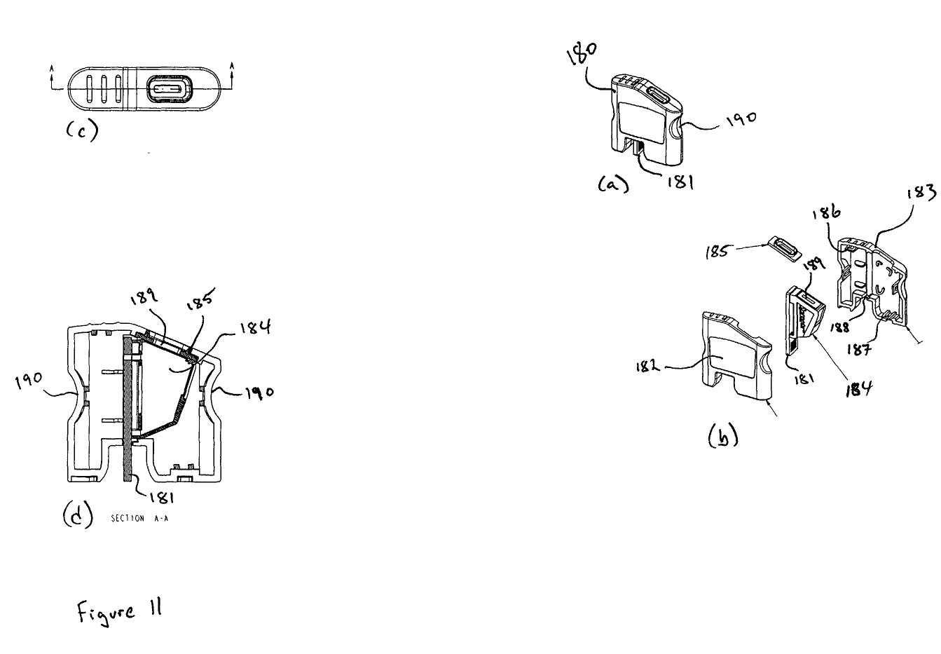

FIGS. 5a-f illustrate various isometric views of a modular sensor unit 20 according to an embodiment of the present invention. In this embodiment, modular sensor unit 20 includes a cover 100, a thermal block 110, a platform/agitator assembly 120, a base 125, an optical shutter 130, control electronics interface 140, and digital signal processing electronics interface 150. Cover 100 is provided to seal the thermal block 110 and other components from the ambient environment. Thermal block 110 houses multiple sensors, (e.g., up to eight removable sensor modules or cartridges, each including a Spreeta™ 2000 sensor or other sensors). Each sensor module includes a sensor packaged in an individual cartridge which is easily inserted into and removed from an electrical connector 121 (FIG. 10) in the thermal block 110 as will be described below. Control and data signals provided to and from each sensor module in thermal block 110 are preferably received through connector 121. Handle 175 s provided on thermal block 110 to facilitate removal from platform assembly 120. Preferably, thermal block 110 slidably mates with platform 120.

Platform/agitator assembly 120 is configured to removably receive thermal block 110 and provide electrical connections to thermal block 110 for control and data acquisition via interface 160. Thermal block 110 includes a matching interface 122 (FIG. 10) for mating with interface 160. Platform/agitator assembly 120 also provides the means for efficient orbital sample mixing during analysis. In one embodiment, an agitation mechanism, such as rotating member including a motor, a counterbalance affixed to the motor shaft, and a platform affixed to the motor shaft above the counterbalance is provided. In one embodiment, agitation speed is user-programmable, for example, from about 150 to 1000 rpm or more, and the optimal agitation speed is determined by the user. A small radius of orbit (e.g., 0.5 mm) and the shape of the sample wells minimizes vortexing during sample agitation. Thermal block 110 includes a base 170 adapted to slide into slots 165 in the agitator platform 120 and lock in place during use. The agitator assembly 120, in one embodiment, includes a magnetic homing mechanism that assures that thermal block 110 returns to the same location following each analysis.

Optical shutter 130 opens to allow transfer of samples into the sample and pre-conditioning wells, and closes during sample analysis and data acquisition to minimize background noise due to stray light.

The electronics for temperature (heating and cooling) and agitation control as well as the electronics for digital processing of the sensor signals are preferably implemented on one or more PC boards located in the base 125 of the sensor unit 20. For example, in one embodiment, two highly dense PC boards integrate the required electronics. Interface 160 of platform 120 is preferably coupled to electronics interface 140 and/or interface 150 either directly or through electronics integrated in base 125. In this manner control and data signals to and from thermal block 110 are communicated via interface 160. The sensor unit 20 is preferably designed to prevent damage to the electronics by accidental liquid spills. For example, cut-outs are provided in the sides of the sensor unit outer casing to allow liquids to spill down the outside of the sensor unit base, avoiding contact with the electronic assemblies contained in the interior of the base.

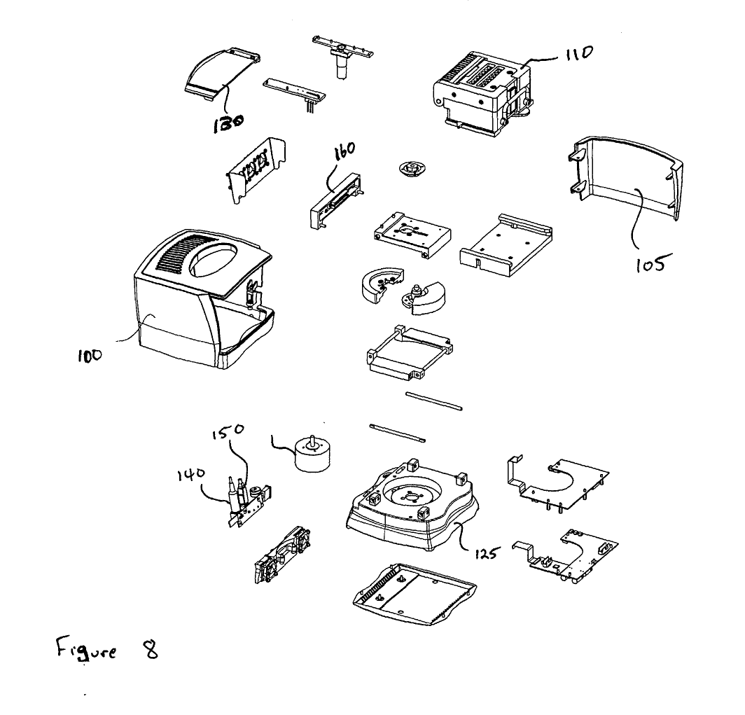

FIGS. 6a-e show various isometric views illustrating the process of removing a thermal block 110 from, or inserting thermal block 110 into, housing 100 of sensor unit 20. A door 105, e.g., attached via hinges, provides an opening for receiving thermal block 110. Handle 175 is used to slidably remove thermal block 110 from housing 100. FIG. 6e also illustrates an isometric view of thermal block 110 in an open state, wherein individual sensor modules 180 may be inserted into or removed from the sensor receiving locations as will be discussed below.

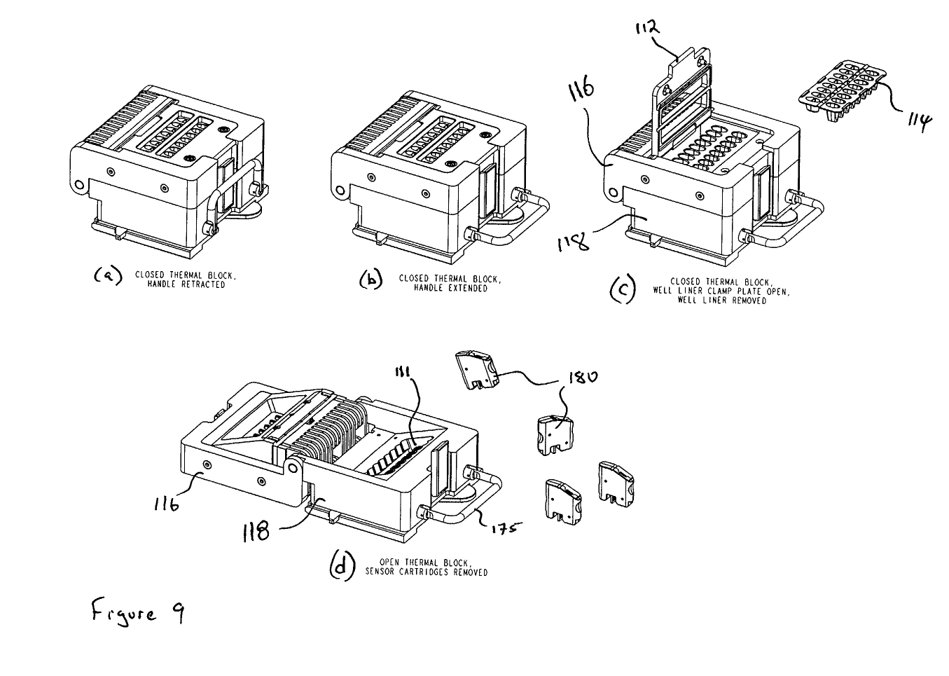

FIGS. 7a and b illustrate detailed cross-sectional views of sensor unit 20, including a loaded thermal block 110, taken at sections A-A and B-B as indicated in FIG. 5g, respectively. As shown, a sensor 184 is located proximal a well 1143, which is provided for delivery of sample to the sensing region of sensor 184. Optional, pre-conditioning wells 1144 are also provided as will be discussed below. Other components include the electronic boards housed in the unit base, agitator assembly (motor, counterbalance and platform), and cooling fans, as well as communications connector/cable 140 (e.g., RS232), and communications connector/cable 150 (e.g., USB 1.x).

FIG. 8 illustrates various components of sensor unit 20 according to an embodiment of the invention, including unit casing 100, front cover 105, thermal block 110, unit base 125, shutter 130, communications connector/cable 140 (e.g., RS232), communications connector/cable 150 (e.g., USB 1.x), and thermal block interface 160. Other components include electronic boards housed in base 125, agitator assembly (motor, counterbalance and platform), cooling fans, and shutter motor and travel rack.

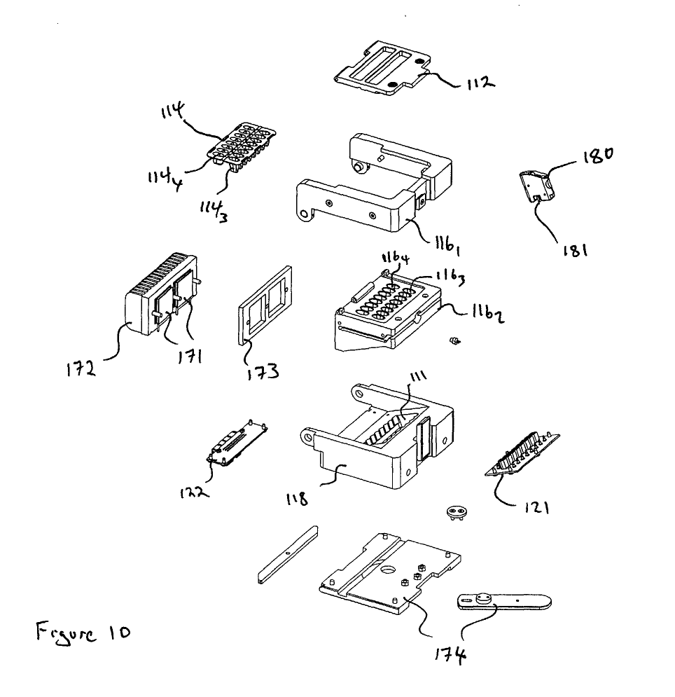

FIGS. 9a-d are isometric views of thermal block 110 according to an embodiment of the invention. In this embodiment, thermal block 110 includes an upper portion 116 that is configured to attach to a lower portion 118. Lower portion 118 includes a sensor location region 111 configured to receive multiple sensor modules 180. Preferably region 111 includes multiple sensor module receiving locations (e.g., eight linearly arranged sensor module receiving locations) spaced such that the sensing region of each sensor module is spaced approximately 9 mm apart. It should be understood that other arrangements (e.g., spacings, dimensions) of sensor modules may be implemented, and that the present embodiment is convenient for use with configurations and spacings compatible with microtiter formatted liquid dispensing mechanisms such as the liquid handling system of the Tecan Systems MSP9000 robot. Upper portion 116 preferably includes a hinged clamp plate provided to secure a well liner 114 proximal the sensor modules in region 111.

FIG. 10 illustrates various components of thermal block 110 according to an embodiment of the invention. As shown, upper portion 116 includes a frame 116₁ that couples to a well region member 116₂, which includes a first plurality of openings 116₃ and a second plurality of openings 116₄ defined therein. First plurality of openings 116₃ are arranged such that they are proximal the sensing regions of the sensor modules 180 inserted in region 111 of lower portion 118 when upper portion 116 is closed over lower portion 118. The second plurality of openings 116₄ are optionally provided to define pre-conditioning wells, e.g., for thermal equilibration of samples and solutions prior to and during analysis. Well liner 114 is configured such that when properly inserted into upper portion 116, wells 114₃ are proximal openings 116₃ and optional wells 114₄ are proximal openings 116₄. The bottom of each well 114₃ includes an opening of sufficient dimension to allow samples to contact the sensing regions on the corresponding sensor modules. Optionally, the well openings 116₃ and 116₄ are covered with rubber septa that can be pierced by the liquid delivery probes of the liquid handling system, and serve to block ambient light from disadvantageously impacting the sensing regions as well as to minimize or eliminate evaporation of analysis solution from the wells during a measurement. An electrical interface module 121 is provided for connecting the card edge connector 181 of each inserted sensor module 180 with processing and control circuitry via interface 122. For example, interface 122 provides for communication with the local signal processing circuitry implemented in base 125 and/or external processing and control circuitry via interfaces 140 and 150. Electrical interface module 121 defines the sensor module receiving locations of thermal block 110, and is preferably configured to securely fit within region 111 of lower portion 118, e.g., with or without securing mechanisms such as screws, soldering or other connection devices and schemes. Peltier effect temperature control element operates as is well known to control the temperature of wells 114₃ and/or wells 114₄.

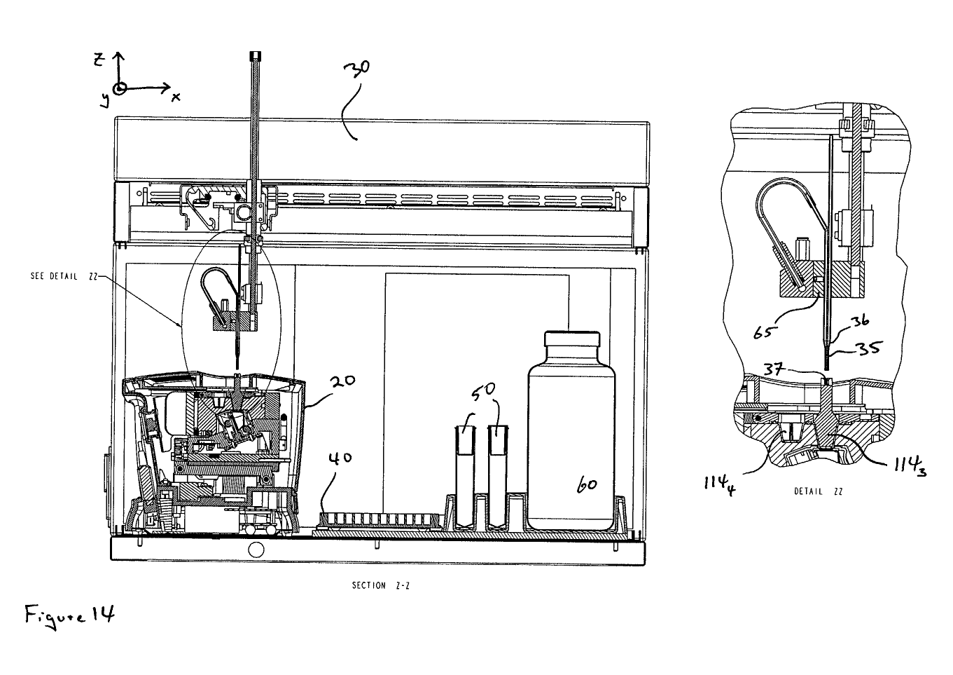

Referring back to FIG. 10, the hinged top of the thermal block 110 is configured to receive plastic (e.g., polypropylene or other durable material) well liner 114, which mates with the silicone gaskets 185 of the array of sensor modules to provide wells 114₃ for holding the samples to be analyzed. Referring now to FIG. 13, there is shown additional views of thermal block 110, including a portion of a cross-sectional view in FIG. 13d. The wells 114₃ each preferably support a volume from approximately 20 μL to about 100 μL or more. Sensor modules with spent sensors are disposable. The well liner 114, in one embodiment, also contains, for example, sixteen “pre-conditioning” wells 114₄ useful for thermal equilibration of samples and solutions prior to and during analysis. Pre-conditioning wells 114₄ are preferably arrayed in two side-by-side linear arrays of eight wells each, although other arrangements may be implemented.

In one embodiment, thermal block 110 provides highly accurate Peltier effect (thermoelectric heating and cooling) control of the sample temperature during analysis. Referring back to FIG. 10, Peltier effect control is provided by two Peltier effect devices 171 optimally affixed to a block 172 (e.g., aluminum) having cooling fins, which is then affixed to block 116 (e.g., aluminum) containing the wells and sensor modules. A rubber (or other insulating material) gasket 173 is fitted around the Peltier effect devices 171 to provide thermal insulation. Alternatively, one or both blocks 172 and 116 may be made of materials other than aluminum having excellent thermal conductivity. In certain embodiments, refractive index is sensitive to temperature. Sample temperature is preferably maintained to within ±0.2° C. of the set-point over the temperature range 15° C. to 40° C. Additionally, well-to-well temperature uniformity is ≦±0.2° C. over the same temperature range. The thermal block 110, module 180 and sensor materials as well as the surface chemistry are preferably compatible with temperatures as high as 65° C. A latching device 174 is preferably provided in the base of the thermal block 110 to secure the block in place in the sensor unit 20 during operation.

D. Sensor Module

FIG. 11a-d illustrate a sensor module assembly (e.g., cartridge) 180 according to an embodiment of the present invention. FIG. 11a illustrates a complete sensor module assembly 180 including protruding connector 181. FIG. 11b illustrates separated components of sensor module assembly 180 according to one embodiment, including side portions 182 and 183. Side portions 182 and 183 are configured to attachably mate with each other and secure a sensor 184 therein. Preferably each portion is made of plastic, but other durable materials may be used. In one embodiment, tabs 186 and corresponding receptors 187 are provided on each portion to securely “snap” portions 182 and 183 together. A gasket 185 (e.g., slotted silicone) sits atop the sensing surface of each sensor 184, and defines the sensing region/area 189 on which the desired sample is contacted. For example, in the case of Spreeta™ 2000 and similar SPR-based sensors, gasket 185 defines the area of the metallic, e.g., gold, film on which the desired sample, e.g., biomolecule, is immobilized (e.g., with an area of about 12.5 mm²). A slot 188 is provided in portion 183 to allow connector 181 to be exposed for electrical communication with interface module 121 of thermal block 110. Preferably indents 190 are provided to facilitate manual insertion and removal of sensor modules 180. FIG. 11d illustrates a cross-sectional view along the lines A-A of FIG. 11c (top view) of a closed sensor module (cartridge) 180 including a sensor 184 and gasket 185.

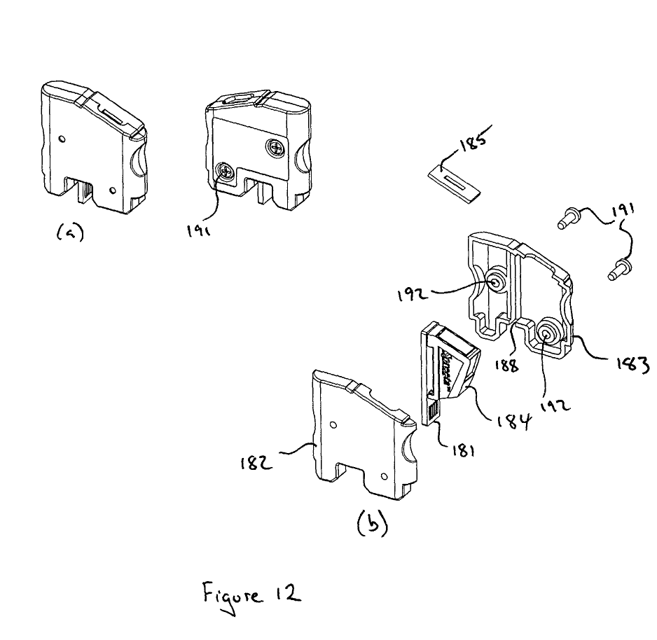

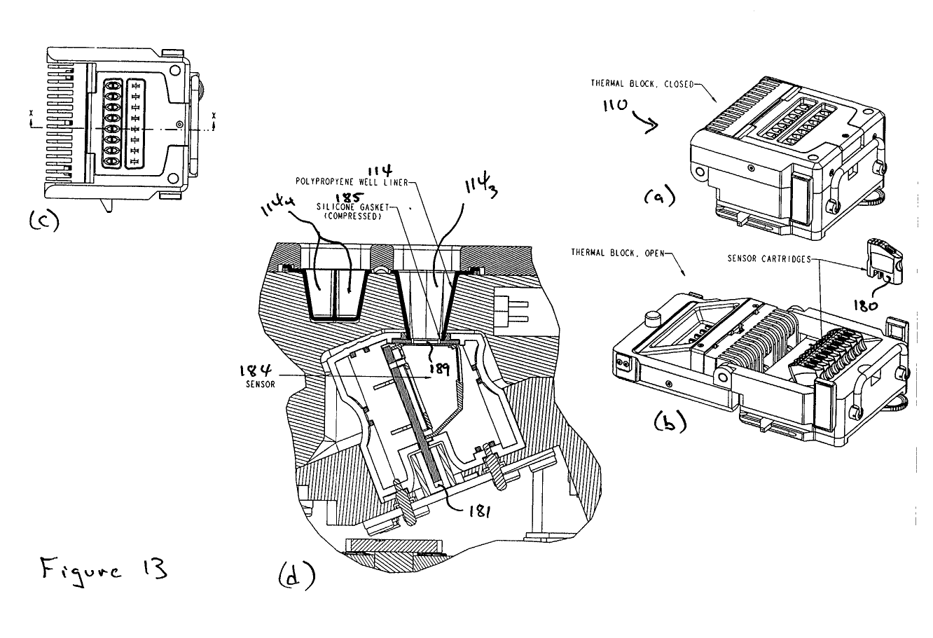

FIG. 12 illustrates a sensor module assembly 180 according to another embodiment, wherein portions 183 and 182 are securely attached via connectors 191. Connectors 191 preferably include threaded or unthreaded screws that couple the two portions together via (threaded or unthreaded) receiving holes 192. However, it should be appreciated that other connection mechanisms may be implemented, for example, zero insertion force connectors, pins, glue, etc.

E. General

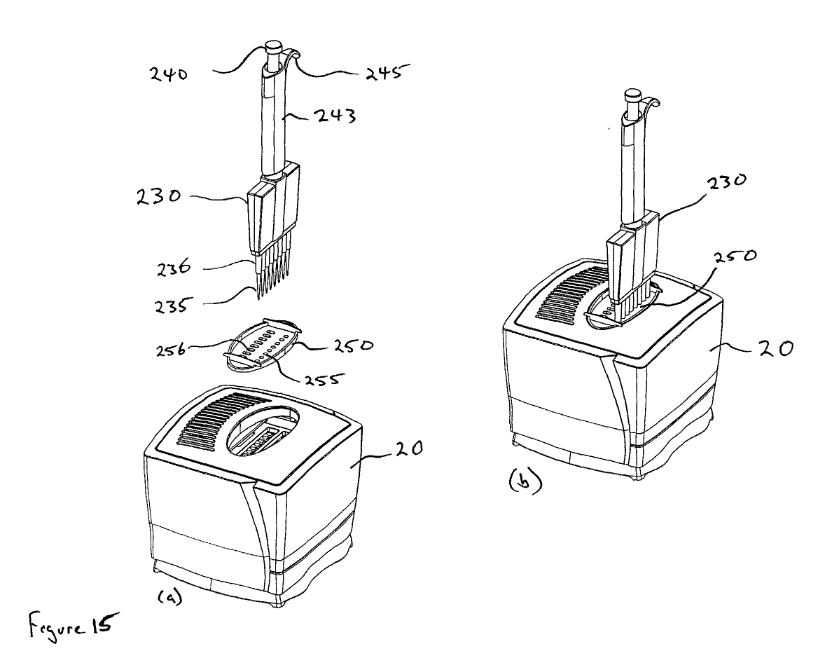

FIGS. 14a and b illustrate a side view of analytical system 10 and a close-up of the liquid handling system in position proximal the sample wells 114₃ of sensor unit 20, respectively, according to an embodiment of the invention. Liquid handling system 30 is configured with motors as are well known for translating head 65 laterally along the x-y plane and vertically along the z-direction. Thus, for example when positioned above wells 114₃, the z-axis motor is activated to move needle 35 into position for delivery of the desired liquid into wells 114₃. Similarly, when positioned above a microtiter sample well plate 40, head 65 is lowered to the appropriate level to retrieve the desired sample solution. In one embodiment, needle 35 includes a portion 36 that is wider than that of the tip. A needle receiving member 37 having an orifice substantially complementary in size to needle 35 is provided to receive needle 35 and prevent portion 36 from passing, thereby preventing needle 35 from contacting and potentially damaging the sensor surface. Receiving member 37 may be provided, for example, as a portion of shutter 130, or as a separate insert (see, e.g., insert 250 of FIG. 15).

FIG. 15 illustrates an analytical system 10 including an insert 250 optimally configured to allow manual delivery of samples to sensor unit 20 according to an embodiment of the invention. Dispenser 230 in the figure represents any of a large number of commercially available high-accuracy liquid delivery devices or pipettors commonly used in scientific laboratories (e.g., Pipetman or Finnpipette devices). The manual application insert 250 provided in this embodiment is placed over the wells 114 of thermal block 110. Insert 250 is adapted to fit within the opening to sensor unit 20 (with shutter 130 removed or in addition to shutter 130 with shutter 130 retracted) as shown such that guide holes 255 receive the liquid delivery tips of the commercial liquid delivery device 230 as shown in FIG. 15b. In this manner liquids may be provided manually to sensor surfaces via wells 114₃. Portions 236 are preferably larger in diameter than guide holes 255 and needles 235, which are smaller in diameter than guide holes 255. In this manner, the tips of the liquid delivery device are prevented from entering too far into wells 114 so as to prevent damage due unintended contact of the tips with the sensor surfaces. Optional holes 256 are provided in embodiments including pre-conditioning wells 114₄. In some devices, a handle 243 is provided to allow a user to manually grip device 230, and tab 245 is provided to contact the index finger of the user when gripping the handle portion 243. Button 240 may be depressed, e.g., with the users thumb, to release liquids.

F. Software Applications

FIG. 17 illustrates a general overview of a computer-based analysis system 210 including a host computer system 250 communicably coupled to a molecular interaction analysis system 10 according to an embodiment of the present invention. In system 210, computer system 250 is preferably directly coupled to sensor unit 20 and/or robot 30 as above using PCI, USB 1.x/2.x, FireWire (also known as IEEE 1394), serial port (RS232), Ethernet, etc., interfaces for communicating data and control commands, although host computer system 250 may be coupled over a network, e.g., over any LAN or WAN connection, to system 10. System 210, and in particular computer system 250, are configured according to the present invention to perform automatic molecular interaction assays in response to user input criteria. It should be understood that, although only one computer system 250 is shown and discussed herein, any number of computer systems may be communicably coupled to system 10, for example, forming a network. The analysis system of the present invention advantageously allows a user to perform molecular interaction analyses and automatically process and display the resulting data in default or user-configured formats.

Several elements in the system shown in FIG. 17 include conventional, well-known elements that need not be explained in detail here. For example, each computer system 250 could include a desktop personal computer, workstation, laptop, or any other computing device capable of interfacing directly or indirectly with system 10, e.g., directly or over a network. Computer system 250 typically includes one or more user interface devices 22, such as a keyboard, a mouse, touch-screen, pen or the like, for interacting with a graphical user interface (GUI) provided by the software applications on a display 23 (e.g., monitor screen, LCD display, etc.).

According to one embodiment, computer system 250 and all of its components are operator-configurable using an application including computer code run using a central processing unit 253 such as an Intel Pentium processor or the like. Computer code including instructions for operating and configuring computer system 250 to process data content and communicate with, and control, system 10 as described herein is preferably stored on a hard disk, but the entire program code, or portions thereof, may also be stored in any other volatile or non-volatile memory medium or device as is well known, such as a ROM or RAM, or provided on any media capable of storing program code, such as a compact disk (CD) medium, digital video disk (DVD) medium, a floppy disk, and the like. As shown in FIG. 17, for example, the code, or portions thereof, is included in a portable memory medium 262 (e.g., floppy, CD, DVD, etc. disk medium) that is readable by computer system 250 via an appropriate memory drive (not shown) coupled to, or integrated in, computer system 250. Additionally, the entire program code, or portions thereof, may be transmitted and downloaded from a software source, e.g., from a server system (not shown) to computer system 250 over the Internet as is well known, or transmitted over any other conventional network connection (e.g., extranet, VPN, LAN, etc.) using any communication medium and protocols (e.g., TCP/IP, HTTP, HTTPS, Ethernet, etc.) as are well known. It should be understood that computer code for implementing aspects of the present invention can be implemented in machine language, assembly language, Cobol, C/C++ (and related languages), Pascal, Java, BASIC, etc., which can be executed on computer system 250.

According to one embodiment, one or more applications (represented as module 255) executing on computer system 250 include instructions for running molecular interaction analysis assays and processing the results based on user input criteria. Application(s) 255 is preferably downloaded and stored in a hard drive 252 (or other memory such as a local or attached RAM or ROM), although application(s) 255 can be provided on any software storage medium such as a floppy disk, CD, DVD, etc. as discussed above. In one embodiment, application module 255 includes various software modules for processing data content, such as a user interface communication module 257 for communicating control commands to system 10 through a communication port 260, and for receiving data from system 10. All components of computer system 250 are connected by one or more buses as is well known.

Two software applications are provided in one embodiment: an Instrument Control/Data Acquisition application and a Data Analysis/Modeling application, which are designed to assist users in setting up and performing experiments and in analyzing the resulting data in the context of several mathematical models which describe molecular interactions, as well as to provide expert users with sufficient flexibility to create their own unique methods and analyze data according to non-standard models.

The Instrument Control/Data Acquisition application provides graphical user interface (GUI) functionality, including providing various user-interactive screens, for example, Users, Plate ID, Methods, Sensors, Experiments and Reports screens. The Users screen lists all authorized users of the instrument, along with any permissions or privileges assigned to them (e.g., access to other users' methods, ability to modify instrument parameters). The Plate ID screen provides a graphical and tabular interface for the user to input sample information such as source, location in sample plate, etc. The Methods screen lists all of the methods available to the logged-in user and allows the user to create new methods or edit existing methods. Methods embody a series of commands for controlling the molecular interaction analysis experiment such as opening and closing shutter, setting parameters such a temperature and agitation rate, pick up and dispensing of sample, etc. Method creation and editing utilize a graphical interface, with icons representing fundamental hardware processes that are added to a method using “point-and-click” functionality. Certain hardware processes (e.g., “transfer sample”, “start acquisition”, “wash probe”) have user-selectable parameters (e.g., volume, from position/to position, data acquisition period). Methods and sequences may be run from this screen as well. The Experiments screen provides a mechanism for experimental design and execution and utilizes data from sensor database, plate ID database and method database. This affords maximum flexibility with respect to how samples in the sample plates are handled such that each column of samples may be analyzed using a different method. This design allows for unattended operation during analysis of all samples on the deck. When an experiment or method is running, the active process is highlighted on screen, and if acquisition is occurring, the data is graphically displayed (both SPR curves as well as calculated curve minimum versus time). The user can select how many channels of data are displayed simultaneously. Data is preferably stored in an SQL-compatible data base, and can optionally be exported as Microsoft Excel spreadsheets or text files. The Sensors screen details information about each of the sensor positions (e.g., sensor installed, sensor initialized, sensor serial number, sensor use history). It also maintains a database of all sensors that have been used in the instrument. The Reports screen provides printable listings of methods, sensors and users.

Experienced users may access the Instrument screen in the Instrument Control/Data Acquisition software. This allows the user to set various instrument parameters prior to running a method (e.g., data acquisition rate, number of SPR curves averaged per data point, LED brightness, etc.).

The Data Analysis/Modeling application assists users in selecting potential models of the interaction under study, fit the acquired data to the models, and assess the “goodness-of-fit” to each model. Depending on the experimental setup, users can obtain rate constants, equilibrium constants and component concentrations using first or second order interaction models. The user can select from non-linear least squares (see, O'Shannessy et al., Anal. Biochem. 212, 457-468 (1993)) and global analysis (see, Beechem, J. M., Meth. Enzymol. 210, 37-54 (1992)) curve-fitting routines from which to extract the parameters of interest. Residuals for each curve fit are plotted to assist the user in qualitatively assessing the “goodness-of-fit”. Experienced users can import more complex interaction models if desired.

F. Examples

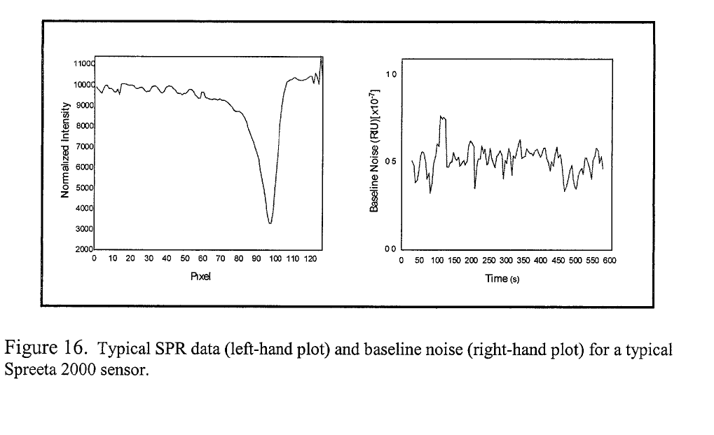

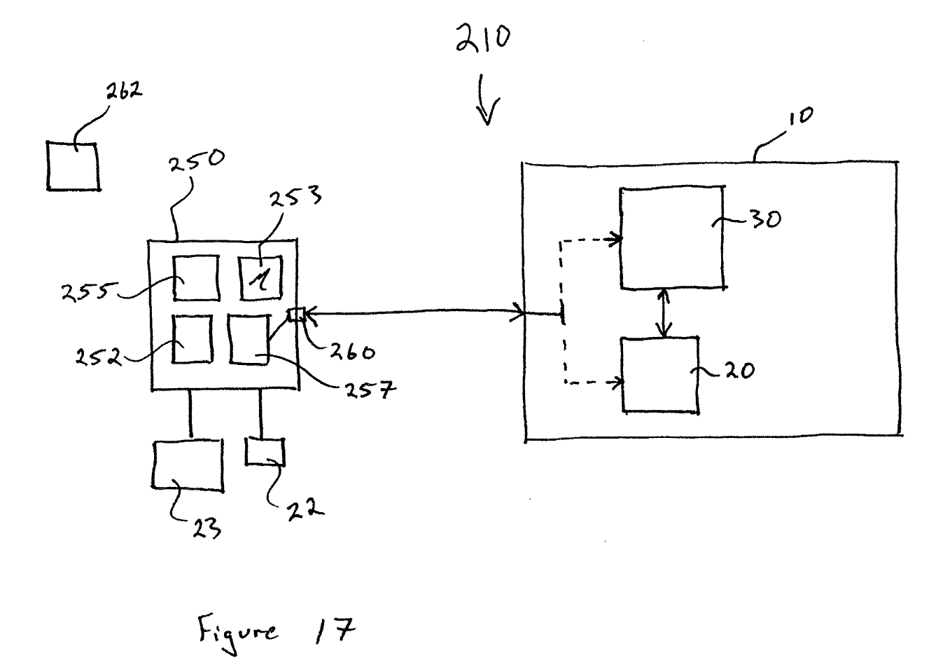

In certain aspects, a system according to the present invention is able to acquire raw SPR data from the sensors at up to 400 curves per second. In one embodiment, the curves are averaged on-the-fly and the minimum of the each averaged curve is calculated by the DSP electronics before being sent to the host computer. FIG. 16 shows sample SPR data from a Spreeta™ 2000 sensor taken using the sensor unit 20 of the present invention. The sample is pure water; the sensor was initialized in air to provide the background blank. The plotted curve represents the average of 200 individual scans acquired in one second. Baseline noise was determined by acquiring averaged SPR curves every second for 600 seconds and calculating the position of the minimum of each curve using a first moment of resonance below baseline algorithm (see, Chinowsky et al., Sens. Actuators B 54, 89-97 (1999)). The plot of the minimum versus time was analyzed using a sliding 60 second window to calculate the RMS noise. The trace shown is a plot of the calculated noise at 5 second intervals, plotted at the endpoint of the time window. The typical average noise value is <1×10⁻⁷ refractive index units (RIU).

Co-pending U.S. patent application Ser. Nos. [ ] (Attorney docket No. 17635-001610), and [ ], (Attorney docket No. 17635-001710), filed on even date herewith, and previously incorporated by reference, each disclose additional examples including sample and sensor surface preparations and experimental data including sensorgrams.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

What is claimed is:

1. A sensor system comprising:
a sensor holding assembly configured to receive a plurality of SPR-based sensors such that the sensing surfaces of two or more inserted sensors are aligned in an array; and
a liquid handling assembly positioned proximal said sensor holding assembly and having a head including two or more dispensing members, wherein said liquid handling assembly is configured to automatically move said head proximal said sensor holding assembly such that the ends of the two or more dispensing members are proximal the sensing surfaces of the two or more inserted sensors.

2. The system of claim 1, wherein the sensor holding assembly a includes temperature control device integrated therein for controlling the temperature of substances proximal the sensing surfaces of the two or more inserted sensors.

3. The system of claim 2, wherein the temperature control device includes a Peltier effect element.

4. The system of claim 1, wherein the sensor holding assembly includes a plurality of electrical connectors that define sensor receiving locations within the sensor holding assembly, wherein the electrical connectors provide a communication path to control circuitry.

5. The system of claim 4, wherein each of the inserted sensors includes an interface for communicating control and data signals, wherein when inserted into the holding assembly each sensor interface mates with a corresponding electrical connector.

6. The system of claim 5, wherein the control circuitry is integrated in the sensor holding assembly.

7. The system of claim 6, wherein the sensor holder assembly includes a communication interface, and wherein the control circuitry is communicably coupled to a host computer via the communication interface.

8. The system of claim 7, wherein the communication interface includes one of a USB interface, a PCI interface and a FireWire interface.

9. The system of claim 6, wherein the control circuitry is coupled to the liquid handling assembly, and wherein the control circuitry provides control signals to the liquid handling assembly for controlling movement of the head.

10. The system of claim 1, wherein each inserted sensor is contained in a sensor module configured to hold the sensor and mate with a corresponding receiving location within the sensor holding assembly.

11. The system of claim 1, wherein the sensor holding assembly further includes a removable well liner configured to provide wells for holding samples proximal the sensing surfaces of the two or more inserted sensors.

12. The system of claim 11, wherein the well liner includes a plurality of secondary wells for holding liquids.

13. The system of claim 1, wherein each sensor includes a Spreeta™ 2000 sensor.

14. The system of claim 1, further including a control computer communicably coupled to one or both of the sensor holding assembly and the liquid handling assembly, said control computer adapted to provide control signals for controlling operation of the liquid handling assembly and the sensors in the sensor holding assembly.

15. The system of claim 14, wherein the control computer is further adapted to receive and process data signals received from the sensors in the sensor holding assembly.

16. The system of claim 15, wherein the control computer provides a graphical user interface on a display device, the graphical user interface including options for displaying processed data and user selectable control parameters.

17. The system of claim 1, wherein the sensing surfaces are aligned in a linear array.

18. The system of claim 1, wherein the spacing between each of sensing surfaces of the two or more inserted sensors are compatible with microtiter formats.

19. The system of claim 18, wherein the spacing between each of sensing surfaces of the two or more inserted sensors is approximately 9 mm.

20. The system of claim 1, further comprising a sample holder including two or more samples, wherein the liquid handling assembly is further configured to automatically move said head proximal the sample holder and retrieve samples with the two or more dispensing members and thereafter automatically deliver the retrieved samples proximal the sensing surfaces of the two or more inserted sensors.

21. The system of claim 20, wherein the liquid handling assembly includes a base, and wherein the sensor holding assembly and sample holder are attached to said base.

22. The system of claim 1, wherein the sensor holding assembly includes an agitation mechanism configured to agitate the assembly so as to induce mixing of materials proximal the sensing surfaces of the two or more inserted sensors.

23. An apparatus for holding two or more SPR-based sensors, each sensor having a sensing surface, the apparatus comprising:
a base;
a platform coupled to said base; and
a sensor holding block configured to removably attach to said platform, said block including two or more sensor receiving locations, each location configured to receive one of said sensors, wherein said receiving locations are arranged so as to present the sensing surfaces in an aligned array.

24. The apparatus of claim 23, wherein the sensor holding block includes a removable well liner that provides a well proximal the sensing surface of each inserted sensor.

25. The apparatus of claim 24, wherein the well liner includes an array of secondary wells for holding liquids.

26. The apparatus of claim 23, wherein the sensor holding block includes eight sensor receiving locations aligned in a linear array.

27. The apparatus of claim 23, wherein the sensor holding block includes a temperature control element configured to control the temperature of substances proximal the sensing surfaces of inserted sensors.

28. The apparatus of claim 27, wherein the temperature control element includes a Peltier effect device.

29. The apparatus of claim 23, wherein each sensor receiving location includes an electrical connector configured to mate with a corresponding connector on a sensor.

30. The apparatus of claim 29, wherein each sensor is contained in a module configured to hold the sensor and expose the sensor connector.

31. The apparatus of claim 23, wherein the platform includes an agitation mechanism configured to agitate the sensor holding block so as to induce mixing of materials proximal the sensing surfaces of the sensors.

32. The apparatus of claim 23, further including control circuitry integrated in said base for controlling operation of the sensors.

33. The apparatus of claim 23, further including a communication interface for communicating with a host computer.

34. The apparatus of claim 33, wherein the communication interface includes one of a USB interface, a PCI interface and a FireWire interface.

35. The apparatus of claim 23, wherein the sensor receiving locations are arranged so that the spacing between sensing surfaces of inserted sensors is compatible with microtiter spacing formats.

36. The apparatus of claim 23, wherein the sensor receiving locations are arranged so that the spacing between sensing surfaces of inserted sensors is approximately 9 mm.

37. The apparatus of claim 23, further including a housing coupled to the base for enclosing the sensor block and platform.

38. The apparatus of claim 37, wherein the housing includes a door that provides an opening for a user to insert and remove the sensor holding block from the platform.

39. The apparatus of claim 37, wherein the housing includes an opening proximal the sensor receiving locations so as to provide access to the sensing surfaces of sensors inserted in the sensor holding block.

40. The apparatus of claim 37, further including a shutter coupled to the housing for selectively closing said opening.
